(19) United States
(12) Patent Application Publication
(10) Pub. No.: US 2022/0260822 A1
(43) Pub. Date: Aug. 18, 2022

(54) DELTA-BOT TYPE MOTORIZED MICROSCOPE STAGE

(71) Applicant: Eun Geun KIM, Gunpo-si (KR)

(72) Inventor: Eun Geun KIM, Gunpo-si (KR)

(21) Appl. No.: 17/614,212

(22) PCT Filed: May 27, 2020
(86) PCT No.: PCT/KR2020/006849

§ 371 Date: Nov. 24, 2021

(30) Foreign Application Priority Data
May 27, 2019 (KR) 10-2019-0061761
Apr. 13, 2020 (KR) 10-2020-0044800

(51) Int. Cl. G02B 21/26; G02B 21/36

(52) U.S. Cl. CPC G02B 21/26; G02B 21/362

(57) ABSTRACT

A delta-bot type motorized microscope stage includes: a main body unit including a lower frame positioned facing a lower portion of an upper frame, connection frames spaced apart from one another and configured to connect a lower surface of the upper frame and an upper surface of the lower frame, and arms each having one end coupled to each of the connection frames to be movable upward or downward, and the other end fixedly coupled to a movable frame; a plate unit positioned on an upper portion of the movable frame and configured to fix a subject; an objective lens unit positioned on an upper portion of the lower frame and facing the plate; and a drive unit connected to the main body unit and configured to transmit a driving signal so that the movable frame moves in a direction determined by an X-axis, a Y-axis, or a Z-axis.

### BACKGROUND FIELD

The present application relates to a delta-bot type motorized microscope stage.

### DESCRIPTION OF THE RELATED ART

A microscope refers to a device used to enlarge and observe a sample. In the related art, a traditional reflecting microscope has been mainly used, which uses a body tube mounted with an objective lens and an ocular lens and allows a user to observe a sample with the naked eye. Recently, a digital microscope mounted with a digital camera (a photodetector) and a display device, together with or instead of an ocular lens unit, and configured to acquire a digital enlarged image of a sample is widely used. In addition, a confocal microscope has been developed and used as a microscope for observing a three-dimensional microstructure such as a cell or a component. The confocal microscope has a pinhole provided on a route of light from a sample to a photodetector via an objective lens, selectively extracts and observes only light passing through a particular cross-section of a sample (i.e., an image of the particular cross-section), and observes the sample while moving the pinhole in parallel with a thickness direction of the sample, thereby acquiring a stereoscopic image of the sample.

A typical confocal microscope includes a base on which a sample is positioned, a stationary stand fixed and mounted at one side of the base, a movable stand mounted on the stationary stand so as to be movable upward or downward, a body tube unit supported by the movable stand and configured to move upward or downward together with the movable stand, an objective lens unit mounted at a sample side end of the body tube unit and configured to create an enlarged image of the sample, and a stand operating knob used to adjust a height of the body tube unit by moving the movable stand upward or downward.

In addition, an enlarged image of the sample acquired from the body tube unit is displayed on a separate image display device or transmitted to a separate control unit. In an electron microscope such as the confocal microscope and a digital microscope, various optical and electrical devices including the objective lens unit are mounted on the body tube unit depending on characteristics of the microscope, and thus a weight of the body tube unit, which is a z-axis movable module, gradually increases.

Therefore, a significant amount of force is required to move the body tube unit upward or downward (along the z-axis) to adjust a distance between the sample and the objective lens unit. Therefore, a weight uniformization method is used to reduce the influence of the weight of the body tube unit, which occurs at the time of moving the body tube unit upward or downward, by installing a spring on the stationary stand and the movable stand to apply a pulling force in a direction opposite to the gravity. However, even though the weight uniformization method is used as described above, the body tube unit is moved downward unintentionally because of the weight of the body tube unit or the user's carelessness at the time of moving the body tube unit upward or downward by rotating the stand operating knob, which causes an incorrect observation of the sample or a collision between the objective lens unit of the body tube unit and the sample positioned on the base.

The background art of the present application is disclosed in Korean Patent No. 10-1421438.

### SUMMARY

An object to be achieved by the present application is to provide a delta-bot type motorized microscope stage capable of solving a problem that a body tube unit is moved unintentionally because of a weight of the body tube unit or a user's carelessness at the time of moving the body tube unit upward or downward by rotating a stand operating knob, which causes an incorrect observation of a sample or a collision between an objective lens unit of the body tube unit and the sample positioned on a base.

An object to be achieved by the present application is to provide a delta-bot type motorized microscope stage capable of solving a problem that a weight of a body tube unit, which is a z-axis movable module, gradually increases because of various optical and electrical devices, such as an objective lens unit, mounted on the body tube unit depending on characteristics of the microscope.

However, technical problems to be solved by the exemplary embodiment of the present application are not limited to the aforementioned technical problem, and other technical problems may be present.

According to an aspect of the present disclosure, there is provided a delta-bot type motorized microscope stage including: a main body unit including a lower frame positioned to face a lower portion of an upper frame, a plurality of connection frames spaced apart from one another and configured to connect a lower surface of the upper frame and an upper surface of the lower frame, and a plurality of arms each having one end coupled to each of the plurality of connection frames so as to be movable upward or downward, and the other end fixedly coupled to a movable frame; a plate unit positioned on an upper portion of the movable frame and configured to fix a subject; an objective lens unit positioned on an upper portion of the lower frame and provided to face the plate; and a drive unit connected to the main body unit and configured to transmit a driving signal so that the movable frame moves in a direction determined by at least one of an X-axis, a Y-axis, and a Z-axis.

In addition, the delta-bot type motorized microscope stage may further include a light emitting unit positioned on the lower portion of the upper frame and configured to emit light to the plate unit.

In addition, the upper frame and the lower frame may each have an equilateral triangular shape, and the drive unit may be positioned on the lower portion of the upper frame or the upper portion of the lower frame to make the movable frame and the arm lightweight.

In addition, the number of arms to be mounted and the number of connection frames to be mounted may be determined depending on a shape of the upper frame and a shape of the lower frame, and a length of the arm and upward and downward movements of the connection frame may be controlled by the drive unit.

In addition, the delta-bot type motorized microscope stage may further include a sensor unit mounted on the movable frame and configured to detect horizontality of the movable frame, the plurality of arms may be individually controlled by the drive unit and organically operates, and the horizontality of the movable frame may be controlled and maintained depending on information on the horizontality of the sensor unit.

In addition, the drive unit may have modes in which the movable frame and the arm are controlled to observe a sample reaction of the subject positioned on the plate, and the modes may include a rotation mode, a vibration mode, a mixed mode, and a tilting mode.

In addition, a light emitting angle of the light emitting unit may be controlled by the drive unit to observe light at various angles.

In addition, the plurality of arms may have a maximum movement value to prevent the plate unit from coming into contact with the objective lens unit or the light emitting unit.

The technical solution is just illustrative but should not be interpreted as being intended to limit the present application. In addition to the above-mentioned exemplary embodiment, additional exemplary embodiments may be present in the drawings and the detailed description of the invention.

According to the technical solution of the present application, the delta-bot type motorized microscope stage is provided. Therefore, it is possible to improve spatial utilization, control the movement in the direction determined by at least one of the X-axis, the Y-axis, and the Z-axis, and implement delta-bot type motorized microscope stage at comparatively low cost.

In addition, according to the technical solution of the present application, the delta-bot type motorized microscope stage is provided. Therefore, it is possible to perform various modes and enable imaging while reacting the sample.

In addition, unlike a microscope stage in the related art, the heavy motor and devices are fixed to the frame. Therefore, the lightweight plate may move at high speed and assist the repetitive work in the narrow space.

In addition, since the respective shafts organically operate, it is possible to stably move the plate at high speed.

However, the effects, which can be obtained by the present application, are not limited to the above-mentioned effects, and other effects may be present.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a side view of a delta-bot type motorized microscope stage according to an embodiment of the present application;

FIG. 2 is a view illustrating a motorized microscope stage in the related art;

FIG. 3 is a block diagram illustrating a configuration of the delta-bot type motorized microscope stage according to the embodiment of the present application;

FIG. 4 is a perspective view of the delta-bot type motorized microscope stage according to the embodiment of the present application;

FIG. 5 is an enlarged perspective view illustrating an arm, a movable frame, and a connection frame of the delta-bot type motorized microscope stage according to the embodiment of the present application; and

FIG. 6 is an enlarged perspective view illustrating a lower frame of the delta-bot type motorized microscope stage according to the embodiment of the present application.

### DETAILED DESCRIPTION OF THE EMBODIMENT

Hereinafter, exemplary embodiments of the present application will be described in detail with reference to the accompanying drawings so that those with ordinary skill in the art to which the present application pertains may easily carry out the exemplary embodiments. However, the present application may be implemented in various different ways, and is not limited to the exemplary embodiments described herein. A part irrelevant to the description will be omitted in the drawings in order to clearly describe the present application, and similar constituent elements will be designated by similar reference numerals throughout the specification.

Throughout the specification of the present application, when one constituent element is referred to as being “connected to” another constituent element, one constituent element can be “directly connected to” the other constituent element, and one constituent element can also be “electrically connected to” or “indirectly connected to” the other element with other elements therebetween.

Throughout the specification, when one member is disposed “on”, “at an upper side of”, “at an upper end of”, “below”, “at a lower side of”, or “at a lower end of” another member in the present specification of the present application, this includes not only a case where one member is brought into contact with another member, but also a case where still another member is present between the two members.

Throughout the specification of the present application, unless explicitly described to the contrary, the word “comprise” or “include” and variations, such as “comprises”, “comprising”, “includes” or “including”, will be understood to imply the inclusion of stated constituent elements, not the exclusion of any other constituent elements.

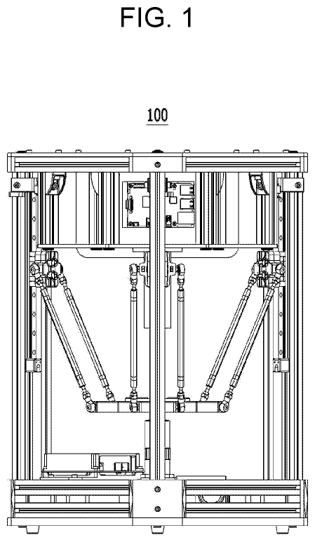

FIG. 1 is a side view of a delta-bot type motorized microscope stage according to an embodiment of the present application. Hereinafter, the delta-bot type motorized microscope stage according to the embodiment of the present application is referred to as the present device 100 for the convenience of description.

The present device 100 may be a device related to a delta-bot type motorized microscope, and more particularly, a device for enlarging and observing a subject provided at an upper end of a plate unit 200 to be described below. The subjects may include, but not limited to, microorganisms, cells, human body tissue, and the like.

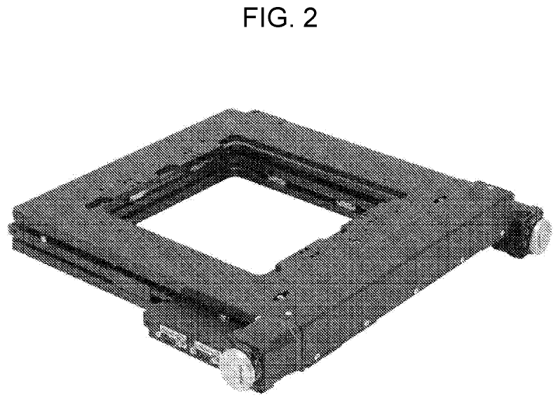

FIG. 2 is a view illustrating a motorized microscope stage in the related art;

Referring to FIG. 2, a motorized microscope stage in the related art generally requires a separate motorized module for a Z-axis movement. In addition, the motorized microscope in the related art has the motorized module for the Z-axis movement, which causes an increase in costs and weight and requires a large space. In addition, in the motorized microscope such as a confocal microscope or a digital microscope, various optical and electrical devices may be mounted depending on characteristics of the motorized microscope, which gradually increases a weight of the body tube unit which is a Z-axis movable module. For this reason, there is a problem in that a quick and stable movement means and a separate module for the Z-axis movement are required. The present device 100 according to the embodiment of the present application may be a device for solving the problem.

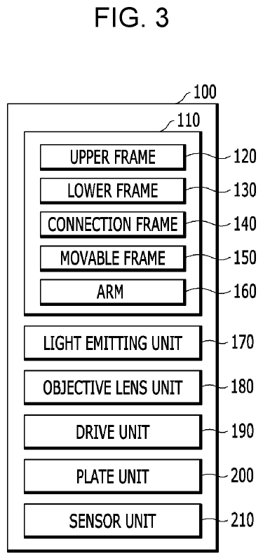

FIG. 3 is a view illustrating a configuration of the present device 100 according to the embodiment of the present application.

Referring to FIGS. 1 and 3, the present device 100 according to the embodiment of the present application may include: a main body unit 110 including a lower frame 130 positioned to face a lower portion of an upper frame 120, a plurality of connection frames 140 spaced apart from one another and configured to connect a lower surface of the upper frame 120 and an upper surface of the lower frame 130, and a plurality of arms 160 each having one end coupled to each of the plurality of connection frames 140 so as to be movable upward or downward, and the other end fixedly coupled to a movable frame 150; a light emitting unit 170; an objective lens unit 180; a drive unit 190; the plate unit 200; and a sensor unit 210.

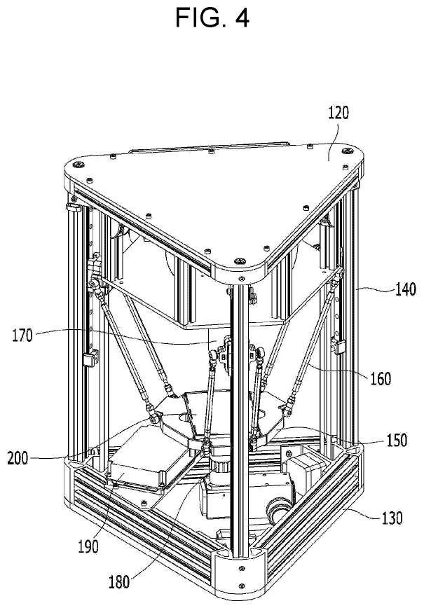

FIG. 4 is a perspective view of the present device 100 according to the embodiment of the present application.

Referring to FIGS. 1, 3, and 4, the upper frame 120 according to the embodiment of the present application may have various shapes. FIG. 1 illustrates the upper frame 120 having an equilateral triangular shape. However, for example, the upper frame 120 may have a square or equilateral pentagonal shape. However, the present disclosure is not limited thereto, an equilateral polygonal shape having the same angle is not necessarily applied, and a polygonal shape or a circular shape may be applied.

The lower frame 130 according to the embodiment of the present application may have the same shape as the upper frame 120. For example, when the upper frame 120 has an equilateral triangular shape, the lower frame 130 may have an equilateral triangular shape. However, the present disclosure is not limited thereto, and the lower frame 130 may have a larger size than the upper frame 120 to make the present device 100 more stable.

The connection frames 140 are spaced apart from one another and connect the lower surface of the upper frame 120 and the upper surface of the lower frame 130 positioned to face a lower portion of the upper frame 120. For example, when the upper and lower frames 120 and 130 each have an equilateral triangular, the vertices of the upper frame 120 are respectively connected to the vertices of the lower frame 130 to maximize the space between the upper frame 120 and the lower frame 130. However, the present disclosure is not limited thereto, and the number of connection frames 140 may be changed depending on the shapes of the upper and lower frames 120 and 130.

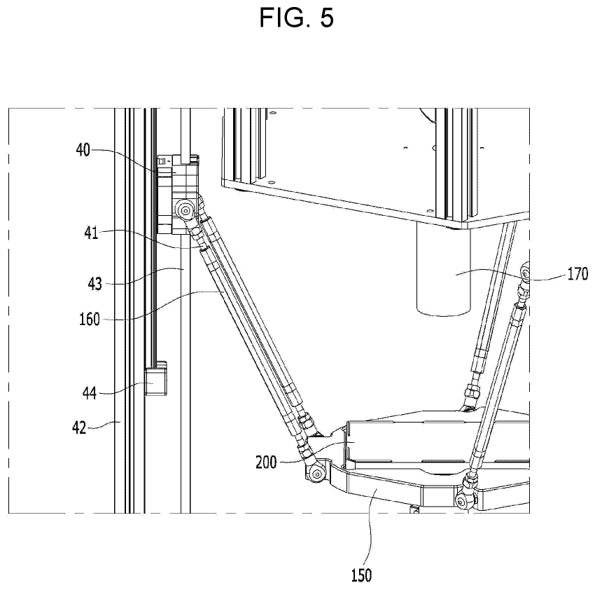

FIG. 5 is an enlarged perspective view illustrating the arm 160, the movable frame 150, and the connection frame 140 of the present module according to the embodiment of the present application.

The connection frame 140 according to the embodiment of the present application may include a coupling frame 42 coupled to a vertical movable part 40 that enables the arm 160 to move along the Z-axis. In addition, the coupling frame 42 may be coupled directly to the movable unit 41 and may move along the Z-axis.

In addition, referring to FIG. 5, the connection frame 14 according to the embodiment of the present application may include a vertical frame 43 coupled to the vertical movable part 40, which enables the arm 160 to move along the Z-axis, and the coupling frame 42 coupled to the upper and lower frame 120 and 130 to support the upper and lower frame 120 and 130. However, the present disclosure is not limited thereto.

In addition, the coupling frame 42 according to the embodiment of the present application may have a transmission means 44 capable of transmitting a control signal of the drive unit 190, which will be described below, to the vertical movable part 40 coupled to the vertical frame 43. However, the present disclosure is not limited thereto.

The movable frame 150 according to the embodiment of the present application is coupled to the plurality of arms 160 such that the horizontality thereof is maintained. The movable frame 150 may be a supporting/fixing means having an upper surface on which the plate unit 200 is placed and fixed. For example, the movable frame 150 may be made of a lightweight and hard material such as PE, PVC, PP, or stainless steel. However, the present disclosure is not limited thereto, a hard and lightweight material, which is well known in the related art or will be developed in the future, may be applied.

The arm 160 according to the embodiment of the present application may include a vertical movable part 40, a retractable part 41, and a coupling means (not illustrated) coupled to the movable frame 150. However, the present disclosure is not limited thereto.

The retractable part 41 according to the embodiment of the present application is a means capable of adjusting a length of the arm 160. The length may be adjusted by the drive unit 190 depending on the user's control instruction. For example, as the retractable part 41, all the length adjustment devices, which are well known in the related art or will be developed in the future, may be applied.

The arm 160 according to the embodiment of the present application may have one end coupled to the coupling frame 42, and the other end coupled to the movable frame 150. In addition, for example, the arm 160 may be coupled to the vertical frame 43 to which the vertical movable part 40 is coupled. However, the present disclosure is not limited thereto. That is, the arm 160 may be coupled to the other components (e.g., the upper frame 120, the lower frame 130, and the like) so as to move along the Z-axis.

The vertical movable part 40 according to the embodiment of the present application may have a maximum movement value. For example, the vertical movable part 40 may prevent the plate unit 200 from coming into contact with the objective lens unit 180 or the light emitting unit 170 when the vertical movable part 40 moves upward or downward along the Z-axis.

The light emitting unit 170 according to the embodiment of the present application may be coupled to the lower surface of the upper frame 120 and emit light toward the plate unit 200 that may be fixed and coupled to the upper end of the movable frame 150. In addition, the light emitting unit 170 may emit light at various angles toward the sample on the plate unit 200 depending on the control signal of the drive unit 190 to be described below in order to image a sample reaction in more detail.

In addition, the light emitting unit 170 according to the embodiment of the present application may have various LEDs to emit light toward the subject in order to concretely observe and image the subject disposed on the upper end of the plate unit 200. For example, the LEDs may include not only LEDs configured to emit visible rays, but also LEDs configured to emit ultraviolet rays or infrared rays. However, the present disclosure is not limited thereto.

The objective lens unit 180 according to the embodiment of the present application may include a set of lenses for enlarging and imaging the subject that may be positioned on the upper end of the plate unit 200. In addition, the type of light emitting unit 170 may be determined depending on the types of LEDs. For example, the types of objective lenses may include an achromatic objective lens, a plan achromatic objective lens, and a plan apochromatic/non-cover glass objective lens. However, the present disclosure is not limited thereto, and it is apparent that all the objective lenses, which are well known in the past or will be developed in the future, may be applied to the present device 100. In addition, because the method of using the objective lenses depending on the types of objective lenses is apparent to those skilled in the art, a specific description thereof will be omitted.

The drive unit 190 according to the embodiment of the present application may include a motor and a circuit for moving the arm 160 and the vertical movable part 40. However, the present disclosure is not limited thereto.

The drive unit 190 according to the embodiment of the present application may organically control the plurality of arms 160 depending on the user's control instruction. For example, the user's control instruction may be an instruction for the movement in at least one of X-axis, Y-axis, and Z-axis directions and a control instruction for changing modes. However, the present disclosure is not limited thereto.

For example, the modes according to the embodiment of the present application may include a rotation mode in which the plate unit 200 rotates in a horizontal direction without moving along the Z-axis, a vibration mode in which the arm 160 vibrates by repeatedly retracting by a fine length, a mixed mode in which both the vibration mode and the rotation mode are performed together to mix the subject on the plate unit 200, and a tilting mode in which the plate unit 200 is tilted by a predetermined angle to disperse or move the subject on the plate unit 200. However, the present disclosure is not limited thereto.

The present device 100 according to the embodiment of the present application may perform the imaging while reacting the sample depending on the above-mentioned modes.

For example, the organic control may mean that when the user's control instruction for moving the movable frame 150 in the horizontal direction according to the embodiment of the present application is transmitted to the drive unit 190, the arm 160 close to the movement direction is retracted, the vertical movable part 40 is moved, and the arm 160 and the vertical movable part 40 at the opposite side are retracted or moved to implement equilibrium between the movable frame 150 and the ground surface. However, the present disclosure is not limited thereto, when the user's instruction is made to changing the mode to the tilting mode, the control may be the organic control for tilting the plate unit by a predetermined angle instead of the organic control for implementing the equilibrium.

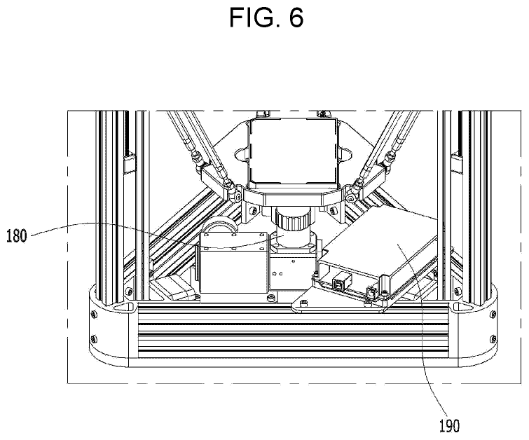

FIG. 6 is an enlarged perspective view illustrating the lower frame 130 of the present device 100 according to the embodiment of the present application.

Referring to FIG. 6, the objective lens unit 180 or the drive unit 190 according to the embodiment of the present application may be positioned on the upper surface of the lower frame 130. However, for example, the drive unit 190 may be embedded in the lower surface of the upper frame 120, the upper surface of the lower frame 130, or the coupling frame 42. However, the present disclosure is not limited thereto, and the drive unit 190 may be mounted on a component (e.g., an upper surface of the lower frame 130), which is not a part that actually moves, in order to minimize power required to move the movable frame 150.

The sensor unit 210 according to the embodiment of the present application may be mounted on the movable frame 150 and detect the horizontality of the movable frame 150. For example, the sensor unit 210 may be positioned on an upper surface, a lower surface, or a lateral surface of the movable frame 150. The information on the horizontality of the movable frame 150 measured by the sensor unit 210 is transmitted to the drive unit 190. The drive unit 190 may control the horizontality of the movable frame 150 by controlling the retraction and the extension of the arm 160 and the upward and downward movements of the vertical movable part 40 depending on the information on the horizontality. However, the present disclosure is not limited thereto.

According to the delta-bot type motorized microscope stage according to the embodiment of the present application, the heavy motor and devices (the objective lens unit 180 or the like) are fixed to the frames (the coupling frame 42, the upper frame 120, the lower frame 130, the connection frame 140, and the like), which increases spatial utilization. Further, the parts (the movable frame 150, the arm 160, the vertical movable part 40, and the like), which actually move, are very lightweight, and thus may move at high speed. In addition, the X-axis control, the Y-axis control, and the Z-axis control may be simultaneously performed, and the control may be implemented at comparatively low cost.

It will be appreciated that the exemplary embodiments of the present application have been described above for purposes of illustration, and those skilled in the art may understand that the present application may be easily modified in other specific forms without changing the technical spirit or the essential features of the present application. Therefore, it should be understood that the above-described exemplary embodiments are illustrative in all aspects and do not limit the present invention. For example, each component described as a single type may be carried out in a distributed manner. Likewise, components described as a distributed type can be carried out in a combined type.

The scope of the present application is represented by the claims to be described below rather than the detailed description, and it should be interpreted that the meaning and scope of the claims and all the changes or modified forms derived from the equivalent concepts thereto fall within the scope of the present application.

What is claimed is:

1. A delta-bot type motorized microscope stage comprising:
a main body unit comprising a lower frame positioned to face a lower portion of an upper frame, a plurality of connection frames spaced apart from one another and configured to connect a lower surface of the upper frame and an upper surface of the lower frame, and a plurality of arms each having one end coupled to each of the plurality of connection frames so as to be movable upward or downward, and the other end fixedly coupled to a movable frame;
a plate unit positioned on an upper portion of the movable frame and configured to fix a subject;
an objective lens unit positioned on an upper portion of the lower frame and provided to face the plate; and
a drive unit connected to the main body unit and configured to transmit a driving signal so that the movable frame moves in a direction determined by at least one of an X-axis, a Y-axis, and a Z-axis.

2. The delta-bot type motorized microscope stage of claim 1, further comprising:
a light emitting unit positioned on the lower portion of the upper frame and configured to emit light to the plate unit.

3. The delta-bot type motorized microscope stage of claim 1, wherein the upper frame and the lower frame each have an equilateral triangular shape, and the drive unit is positioned on the lower portion of the upper frame or the upper portion of the lower frame to make the movable frame and the arm lightweight.

4. The delta-bot type motorized microscope stage of claim 1, wherein the number of arms to be mounted and the number of connection frames to be mounted are determined depending on a shape of the upper frame and a shape of the lower frame, and
wherein a length of the arm and upward and downward movements of the connection frame are controlled by the drive unit.

5. The delta-bot type motorized microscope stage of claim 4, further comprising:
a sensor unit mounted on the movable frame and configured to detect horizontality of the movable frame,
wherein the plurality of arms is individually controlled by the drive unit and organically operates, and the horizontality of the movable frame is controlled and maintained depending on information on the horizontality of the sensor unit.

6. The delta-bot type motorized microscope stage of claim 4, wherein the drive unit has modes in which the movable frame and the arm are controlled to observe a sample reaction of the subject positioned on the plate, and
wherein the modes comprise a rotation mode, a vibration mode, a mixed mode, and a tilting mode.

7. The delta-bot type motorized microscope stage of claim 2, wherein a light emitting angle of the light emitting unit is controlled by the drive unit to observe light at various angles.

8. The delta-bot type motorized microscope stage of claim 2, wherein the plurality of arms has a maximum movement value to prevent the plate unit from coming into contact with the objective lens unit or the light emitting unit.
